(19) United States
(12) Patent Application Publication
(10) Pub. No.: US 2011/0008491 A1
(43) Pub. Date: Jan. 13, 2011

(54) DOUGH COMPOSITION

(76) Inventors: Ellen Maria Elizabeth Mulder, Wormerveer (NL); Miriam Aldegonda Josephina Van Wanroij, Wormerveer (NL); Ulrike Schmid, Wormerveer (NL)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/740,290

(22) PCT Filed: Oct. 22, 2008
(86) PCT No.: PCT/EP2008/008921

§ 371 Date: Aug. 9, 2010

(30) Foreign Application Priority Data
Oct. 29, 2007 (EP) 07254274.9

(51) Int. Cl. A21D 2/16; A21D 10/02; A21D 13/00; A21D 8/04

(52) U.S. Cl. 426/20; 426/549; 426/62; 426/64; 426/556

(57) ABSTRACT

A dough composition comprising flour, water and a fat phase, wherein the fat phase comprises at least 40% by weight conjugated linoleic acid or a derivative thereof (CLA). There is also disclosed a dough composition comprising flour and a fat phase, wherein the fat phase comprises a fat A and a fat B, wherein fat A comprises at least 90% by weight conjugated linoleic acid or a derivative thereof (CLA) and wherein fat B has an N₂₀-value greater than about 10.

This invention relates to a dough composition and to a method for its production.

The nutritional value of the diet has come under increasing scrutiny. Food supplements are often taken by individuals in order to obtain nutritional benefits. However, food supplements are typically in the form of capsules or the like and have the disadvantage that they are inconvenient in that individual has to remember to take them. Food supplements of this type are typically not flavoured and are not attractive to many consumers.

Nutritional supplements have been incorporated into food products but the resulting food products can have an undesirable taste and the incorporation of the supplement can have a deleterious effect on the stability of the products.

Conjugated linoleic acid (CLA) is a conjugated dienoic fatty acid having 18 carbon atoms. As a result of the presence of the two double bonds in CLA, geometrical isomerism is possible and the CLA molecule or moiety may exist in a number of isomeric forms. The cis9, trans11 (“c9t11”) and trans10, cis12 (“t10c12”) isomers of CLA are generally the most abundant and beneficial pharmacological effects have been identified for each of these isomers.

U.S. Pat. No. 6,468,556 discloses the administration of CLA for inhibiting liver fat accumulation. However, this document is not concerned with the stability of its formulations or whether they have an acceptable taste and texture.

JP 2003116449 and JP10127227 disclose the use of fish oil in the preparation of bread.

EP 0 572 051 discloses a liquid improver comprising 75 to 95% by weight vegetable oil having an N₂₀<2.0 (N₂₀ being the solid fat content as measured by NMR).

There remains a need for dough compositions containing CLA that have good organoleptic properties such as taste and mouthfeel. We have now found dough compositions that solve these problems.

According to one aspect of the present invention, there is provided a dough composition comprising flour, water and a fat phase, wherein the fat phase comprises at least 40% by weight conjugated linoleic acid or a derivative thereof (CLA).

Preferably, the fat phase comprises at least 80% by weight CLA.

Conveniently, the fat phase comprises at least 95% by weight CLA.

Advantageously, the flour is prepared from whole grain.

Preferably, the dough composition comprises brown flour.

Conveniently, the dough composition comprises white flour.

Advantageously, the dough composition comprises a leavening agent.

Preferably, the leavening agent is yeast.

Conveniently, the flour is a mixture of wheat with other grains.

Advantageously, the dough composition is free of wheat or gluten.

Preferably, the dough composition is sourdough.

Conveniently, the dough composition comprises one or more additives selected from flavours, colouring agents, vitamins, acidity regulators, preservatives, emulsifiers, antioxidants, dietary fibres and mixtures thereof.

Advantageously, the conjugated linoleic acid is incorporated in the dough composition in the form of a powder.

Preferably, the bread comprises a bread improver.

According to another aspect of the invention, there is provided a bread prepared using the dough composition of the invention.

According to a further aspect of the invention, there is provided a bread improver comprising at least 8% conjugated linoleic acid or a derivative thereof.

Preferably, the bread improver comprises ascorbic acid, sodium metabisuphate, ammonium chloride, amylase and/or protease.

According to a further aspect of the invention, there is provided a process for producing a dough composition of the invention which comprises admixing flour, water, and a fat phase, wherein the fat phase comprises at least 40% by weight CLA to form the dough composition.

Preferably, the process further comprises baking the dough composition.

Conveniently, the CLA is incorporated into the dough composition in the form of a powder.

Advantageously, the powder is produced by spray drying CLA or its derivatives, or a fat comprising CLA acid or its derivatives, with protein and/or carbohydrate.

According to yet further aspect of the invention, there is provided the use of a dough composition, a bread or a bread improver of the invention for a nutritional benefit.

Preferably, the benefit is a weight management effect.

Conveniently, the benefit is a reduced tendency to fluctuation of body weight.

Advantageously, the benefit is related to the prevention or treatment of atherosclerosis.

According to another aspect of the invention, there is provided a dough composition comprising flour and a fat phase, wherein the fat phase comprises a fat A and a fat B, wherein fat A comprises at least 90% by weight conjugated linoleic acid or a derivative thereof (CLA) and wherein fat B has an N₂₀-value greater than about 10.

Preferably, fat B has an N₂₀-value greater than about 20.

Conveniently, fat B has an N₂₀-value in the range of from about 30 to about 80.

Advantageously, the fat phase comprises a blend of fat A and fat B.

Preferably, fat A comprises at least 95% by weight CLA.

Conveniently, fat B is selected from the group consisting of butter, cocoa butter equivalents, cocoa butter, palm oil or fractions thereof, palm kernel oil or fractions thereof, interesterified mixtures of above fats or fractions or hardened components thereof, and from liquid oils, such as sunflower oil, high oleic sunflower oil, olive oil, soybean oil, rapeseed oil, cottonseed oil, safflower oil, high oleic safflower oil, maize only and/or MCT oils and mixtures thereof.

Advantageously, the dough composition comprises flour which is prepared from whole grain.

Preferably, the dough composition comprises brown flour.

Conveniently, the dough composition comprises white flour.

Advantageously, the flour is a mixture of wheat with other grains.

Preferably, the dough composition is free of wheat or gluten.

Conveniently, the dough composition is sourdough.

Advantageously, the dough composition comprises one or more additives selected from flavours, colouring agents, vitamins, acidity regulators, preservatives, emulsifiers, antioxidants, dietary fibres and mixtures thereof.

Preferably, the CLA is incorporated in the dough composition in the form of a powder.

According to another aspect of the invention, there is provided a biscuit prepared using the dough composition of the invention.

According to a further aspect of the invention, there is provided a cake prepared using the dough composition of the invention.

According to yet another aspect of the invention, there is provided puff pastry prepared using the dough composition of the invention.

According to a yet further aspect of the invention, there is provided a process for producing a dough composition of the invention which comprises admixing flour and a fat phase which comprises a fat A and a fat B, wherein fat A comprises at least 90% by weight conjugated linoleic acid or a derivative thereof (CLA) and wherein fat B has an N₂₀ value greater than about 10, to form the dough composition.

Preferably, the process further comprises baking the dough composition.

Conveniently, the CLA is incorporated into the dough composition in the form of a powder.

Advantageously, the powder is produced by spray drying CLA, or a fat comprising CLA, with protein and/or carbohydrate.

Preferably, the process further comprises the step of mixing together fat A with fat B to give the fat phase before the fat phase is admixed with the flour.

Conveniently, the process comprises the steps of adding fat A and fat B to the flour separately.

According to another aspect of the invention, there is provided a use of a dough composition, a biscuit, a cake or puff pastry of the invention for a nutritional benefit.

Preferably, the benefit is a weight management effect.

Conveniently, the benefit is a reduced tendency to fluctuation of body weight.

Advantageously, the benefit is related to the prevention or treatment of atherosclerosis.

Dough compositions of the invention optionally comprise one or more additional additives selected from flavours, colouring agents, vitamins, minerals, acidity regulators, preservatives, emulsifiers, antioxidants, dietary fibres and mixtures thereof. Each of these materials may be a single component or a mixture of two or more components.

Examples of suitable vitamins and minerals include calcium, iron, zinc, copper, phosphorous, biotin, folic acid, pantothenic acid, iodine, vitamin A, vitamin C, vitamin B1, vitamin B2, vitamin B3, vitamin B6, vitamin B9, vitamin B12, vitamin D, vitamin E, and vitamin K. Preferably, when a vitamin or mineral is utilized the vitamin or mineral is selected from iron, zinc, folic acid, iodine, vitamin A, vitamin C, vitamin B2, vitamin B3, vitamin B6, vitamin B12, vitamin D, and vitamin E.

Acidity regulators include organic as well as inorganic edible acids. The acids can be added or be present in their undissociated form or, alternatively, as their respective salts, for example, potassium or sodium hydrogen phosphate, potassium or sodium dihydrogen phosphate salts. The preferred acids are edible organic acids which include citric acid, malic acid, fumaric acid, adipic acid, phosphoric acid, gluconic acid, tartaric acid, ascorbic acid, acetic acid, phosphoric acid, or mixtures thereof. Glucono Delta Lactone (GDL) may also be used, particularly wherein it is desired to reduce pH without introducing excessive acidic, or tart, flavour in the final composition.

Colouring agents including natural and artificial colours may optionally be used. Non-limiting examples of colouring agents include fruit and vegetable juices, riboflavin, carotenoids (e.g. p-carotene), turmeric, and lycopenes.

Dietary fibres are complex carbohydrates resistant to digestion by mammalian enzymes, such as the carbohydrates found in plant cell walls and seaweed, and those produced by microbial fermentation.

Preservatives may be selected from the group consisting of sorbate preservatives, benzoate preservatives, and mixtures thereof.

Antioxidants include, for example, natural or synthetic tocopherols, TBHQ, BHT, BHA, free radical scavengers, propylgallate, ascorbylesters of fatty acids and enzymes with anti-oxidant properties.

As used herein, the foam ‘liquid oil’ refers to a fat that is liquid at room temperature, i.e. at about 25° C. Examples of liquid oils include vegetable oils such as extra virgin olive oil, virgin olive oil, native olive oil and peanut oil.

The fat in the dough composition of the invention comprises at least 40% by weight of the fat phase of conjugated linoleic acid (CLA) or a derivative thereof. Preferably, at least 50% by weight, for example at least 60%, at least 70%, at least 80% or at least 90% by weight of the fat phase is conjugated linoleic acid (CLA) or a derivative thereof. The upper limit of CLA in the fat phase may be 95% or 100% by weight. The amount of CLA in the fat is based on the total weight of fatty acids in the fat (calculated using fatty acid methyl ester analysis). The term “CLA”, as used herein refers to conjugated linoleic acid and its derivatives. The CLA may be used in the form of the free acid.

Derivatives of conjugated fatty acids include salts and esters thereof, or a mixture of two or more of these materials. Salts are non-toxic, pharmaceutically acceptable and/or acceptable for use in food products and/or pharmaceuticals and include, for example, salts with alkali metals and alkaline earth metals such as sodium, calcium and magnesium, preferably sodium. Esters include, for example, mono-, di- and tri-glycerides and mixtures thereof, and C₁ to C₆ alkyl esters (where the alkyl group can be straight chain or branched), as well as esters formed with alcohols that are acceptable in food products or pharmaceutical products, such as are disclosed in EP-A-1167340, the contents of which are incorporated by reference herein. Suitable alcohols include terpene alcohols or sesquiterpene alcohols, for example menthol, isopulegol, menthenol, carveol, carvomenthenol, carvomenthol, isobornylalcohol, caryophyllenealcohol, geraniol, farnesol and citronellol.

The preferred form of CLA for use in the invention is as a glyceride. Particularly preferred are diglycerides and triglycerides, with triglycerides being even more preferred.

The CLA may comprise one isomer or a mixture of two or more different isomers including: cis, cis; cis, trans; trans, cis; and trans, trans isomers. Preferred isomers are the trans10, cis12 and cis9, trans 11 isomers (also referred to herein as t 10c12 and c9t11, respectively), including these isomers in relatively pure form, as well as mixtures with each other and/or mixtures with other isomers. More preferably, the conjugated linoleic acid or derivative thereof comprises trans10, cis12 and cis9, trans11 isomers and the weight ratio of trans10, cis12 isomer to cis9, trans11 isomer or vice versa is at least 1.2:1, such as 1.3:1, even more preferably at least 1.5:1, e.g., in the range 1.5:1 to 100:1 or 1.5:1 to 10:1, such as a 60:40 or 80:20 mixture of the trans10, cis12:cis9, trans11 isomers. Particularly preferred are compositions comprising the trans10, cis 12 isomer or the cis9, trans 11 isomer as the major isomer component i.e., present in an amount of at least 55%, preferably at least 60%, more preferably at least 70%, even more preferably at least 75%, most preferably at least 80%, such as at least 90% or even 100% by weight based on the total amount of conjugated linoleic acid. For example, the CLA may comprise c9t11 and t10c12 isomers and the weight ratio of the c9t11 to t10c12 isomers may be from 99:1 to 1 to 99, preferably from 90:10 to 10:90 most preferably from 80:20 to 20:80.

CLA can be produced in conventional ways. For example, CLA can be produced by known methods, such as that described in EP-A-902082, the contents of which are incorporated herein by reference. CLA products that are enriched in one or more isomers are disclosed in WO 97/18320, the contents of which are also incorporated herein by reference.

The CLA is optionally blended with additional fatty acids or glycerides before being used in the fat of the present invention. When the compositions contain one or more fatty acids and/or glycerides in addition to the CLA, the additional fatty acid(s) and/or glycerides are preferably selected from liquid oils, such as soybean oil, sunflower oil, olive oil, rape seed oil and cotton seed oil; cocoa butter and cocoa butter equivalents; palm oil and fractions thereof; enzymically made fats; fish oils and fractions thereof; gamma linolenic acid and enriched mixtures thereof; hardened liquid oils; and mixtures thereof; oleic acid, taxoleic, pinolenic acid, saturated fatty acids, arachidonic acid and EPA (eicosapentaenoic) and DHA (docosahexaenoic). These other fatty acids may be present as free acids or derivatives in the same way as CLA and are preferably present as glycerides, more preferably triglycerides.

The CLA can be included in the dough of the invention as an oil or in the form of a powder, such as a free flowing powder. CLA and its derivatives in powder form can be produced, for example, by spray drying CLA, or a fat comprising CLA, with protein and/or carbohydrate, with the powder typically comprising from 50 to 95% by weight of fat. A preferred powder comprises 70 to 90% by weight triglyceride of which at least 70% by weight is CLA. It has been found that use of the powder can give extra stability to the dough. Preferably, the powder comprises at least 80% by weight, more preferably at least 90% by weight, most preferably at least 95% by weight CLA or a derivative thereof.

The dough composition of the invention can be used to prepare products having advantageous properties, the dough can be cooked in a known manner, such as baking and frying to give various cooked goods such as bread, biscuits (also referred to as cookies), cakes and puff pastry. The cooked goods have improved characteristics, such as softness, crispness and crunchiness. The cooked goods may also slice well when cut with a knife. The goods may also have good organoleptic characteristics, such as easily dissolving in the mouth without being too dry or damp, and breaking easily (snap). Other advantageous properties include good volume, brittleness, firmness, crispiness and compacity.

The invention may have the beneficial property of preventing the dough and the cooked goods from drying too quickly. The cooked goods also have good crust properties without being too crumbly or crispy.

The use of conjugated linoleic acid or a derivative there of (CLA) also avoids problems of stability encountered with other fats, such as fish oil. The dough compositions of the invention, and goods prepared therefrom exhibit good flavour and taste characteristics. Also, the goods prepared in accordance with the invention have good health effects, for example in weight management and heart health

Also, CLA unexpectedly performs better than other unsaturated oils such as linoleic rich oils, particularly in aspects such as stability during processing and baking, and in terms of good taste and mouthfeel of baked goods. Fats containing at least 80% by weight CLA have these beneficial properties, and fats containing at least 95% by weight CLA also exhibit improved properties.

Also, the dough compositions themselves have improved characteristics, such as in terms of consistency, elasticity and aeration properties. The compositions of the invention provide significant advantages in terms of weight management. The compositions have good taste and also good stability, both in their preparation and storage. Also, the compositions of the invention can offer improved nutritional balance and are easy to use. The compositions in the invention can offer a consumer a nutritional benefit in terms of weight management in particular a reduced tendency to fluctuation of body weight and to prevent atherosclerosis. The listing or discussion of an apparently prior-published document in this specification should not necessarily be taken as an acknowledgement that the document is part of the state of the art or is common general knowledge.

The following non-limiting examples illustrate the invention and do not limit its scope in any way. In the examples and throughout this specification, all percentages, parts and ratios are by weight unless indicated otherwise.

The physical properties of fats can be defined in terms of an N value. This value indicates the percentage of solid fat in a composition at a certain temperature. Thus, the term Nₓ refers to solid fat content at a temperature of x° C., measured by NMR pulse techniques on unstabilised fats. The term ‘unstabilised’ refers to a fat that is melted at 80° C., kept at 60° C. for 5 minutes, cooled to ° C., kept at ° C. for 1 hour and then kept at the measurement temperature x° C. for 30 minutes before analysis.

### EXAMPLES

The breads in the examples were prepared using bread mixes from “Markant meergranen”. All breads were baked with a Panasonic type SD-207 bread baking machine. The program used for the whole grain breads was bake dough/multi grain (5 hours program).

### Example 1

Bread example with Clarinol

| % by weight | Ingredient |
|---|---|
| 37 | Wholemeal flour |
| 16 | Multi-grain mix |
| 3.1 | Clarinol ™ G-80 (80% conjugated linoleic acid) |
| 2.2 | Gluten powder |
| 1.6 | Bread improver |
| 1.6 | Yeast |
| 1.1 | Salt |
| 37.4 | Water till 100% |

The multi-grain mix was soaked in water (27% on flour) for at least 20 minutes. Then all the ingredients were mixed with water (36% on flour), spiral kneaded 3 minutes slow and 3 minutes fast. The rest of water was added (7% on flour) and mixed 1 minute slow and 5 minutes fast. The dough was scaled, formed and leavened for 45 minutes. The dough was formed to long shape and put in baking tin. The loaf was leavened for another 70 minutes. The baking took place at 250/220° C. for 30 minutes.

### Example 2

Bread example with Clarinol G-95

| % by weight | Ingredient |
|---|---|
| 37 | Wholemeal flour |
| 16 | Multi-grain mix |
| 3.1 | Clarinol ™ G-95 (95% conjugated linoleic acid) |
| 2.2 | Gluten powder |
| 1.6 | Bread improver |
| 1.6 | Yeast |
| 1.1 | Salt |
| 37.4 | Water till 100% |

The multi-grain mix is soaked in water (27% on flour) for at least 30 minutes. Then all the ingredients are mixed with water (36% on flour), spiral kneaded 3 minutes slow and 3 minutes fast. The rest of water is added (7% on flour) and mixed 1 minute slow and 5 minutes fast. The dough is scaled, formed and leavened for 45 minutes. The dough is formed to long shape and put in baking tin. The loaf is leavened for another 70 minutes. The baking takes place at 250/220° C. for 30 minutes.

### Example 3

WHOLEMEAL COOKIES WITH CLARINOL ™

| % by weight | Ingredient |
|---|---|
| 38.8 | Whole wheat flour |
| 20.0 | Flour |
| 20.0 | Butter |
| 17.7 | Eggs |
| 3.5 | Clarinol ™ G-95 (95% conjugated linoleic acid) |

Clarinol™ is weighed and mixed with the flour. All other ingredients are added and mixed in mixer to form a sweet short pastry. Then the pastry is cooled to 4° C./39° F. The pastry is rolled out to a thickness of 5-6 mm. Pieces are cut out and brushed with egg yolk. The cookies are baked at 180° C./356° F. for 15 minutes (fan oven). The wholemeal cookies are packed in polypropylene bags.

### Clarinol G-80

### Product Description

Clarinol™ G-80 is an oil high in isomers of Conjugated Linoleic Acid (CLA), mainly in triglyceride form. The two main isomers present are cis-9, trans-11 (c9,t11) and trans-10,cis-12 (t10,c12) CLA, in a 50:50 ratio. Clarinol™ G-80 is made from natural safflower oil by a gentle, proprietary process.

Technical Characteristics (typical values)

| | |
|---|---|
| Free fatty acid as % oleic acid: | 0.7 |
| Peroxide value meq 02/kg: | 0.2 |
| Total CLA %: | 80 |
| c9,t11 + t10,c12 isomers %: | 74.5 |
| Trans fatty acids %: | 0.8 |
| Total saturated fatty acids %: | 7 |

### Clarinol G-95

### Product Description

Clarinol™ G-95 is an oil high in isomers of Conjugated Linoleic Acid (CLA). The two main isomers present are cis-9, trans-11 (c9,t11) and trans-10,cis-12 (t10,c12) CLA, in a 50:50 ratio. Clarinol™ G-95 is made from natural safflower oil by a gentle, proprietary process.

Technical Characteristics (typical values)

| | |
|---|---|
| Free fatty acid as % oleic acid: | 0.7 |
| Peroxide value meq 02/kg: | 0.3 |
| Total CLA %: | 93 |
| c9,t11 + t10,c12 isomers %: | 89 |
| Trans fatty acids %: | 0.8 |
| Total saturated fatty acids %: | 0.5 |

### Example 3

### Comparison of CLA and Sunflower Oil in the Preparation of Bread

The following breads were prepared to compare the use of sunflower oil and CLA. The breads were prepared as described in Example 1 apart from the use of the different oils.

A) 3% sunflower oil in bread
B) 3% of CLA G-80 in bread

The results of evaluation of the breads by a taste panel are set out below. The table below reports how well each of the breads could be cut.

Slice well
when cut?

| Panelist | A | B |
|---|---|---|
| 1 | No | Yes |
| 2 | No | Yes |
| 3 | No | Yes |
| 4 | No | Yes |
| 5 | No | Yes |
| 6 | No | Yes |
| 7 | No | Yes |
| 8 | No | Yes |

The table below reports on the crispiness of the crust, the aeration and the moisture level of the bread:

| | | |
|---|---|---|
| Crispiness | Aeration | Dryness |

| Panelist | A | B | A | B | A | B |
|---|---|---|---|---|---|---|
| 1 | 50 | 50 | 22 | 75 | 25 | 50 |
| 2 | 50 | 35 | 50 | 40 | 60 | 40 |
| 3 | 40 | 40 | 40 | 60 | 35 | 57 |
| 4 | 50 | 50 | 25 | 50 | 50 | 50 |
| 5 | 0 | 0 | 30 | 55 | 40 | 50 |
| 6 | 20 | 20 | 60 | 80 | 60 | 50 |
| 7 | 10 | 20 | 40 | 50 | 40 | 50 |
| 8 | 10 | 25 | 22 | 50 | 35 | 75 |
| Average | 29 | 30 | 36 | 58 | 43 | 53 |

Crispiness: 0 not crispy, 50 crispy, 100 too crispy
Aeration: 0 compact/dense, 50 aerated well, 100 very aerated
Dryness: 0 very moist, 50 moist, 100 very dry

The table below reports on the level of CLA taste and the freshness of the bread:

| | | |
|---|---|---|
| CLA | Freshness | Overall score |

| Panelist | A | B | A | B | A/B |
|---|---|---|---|---|---|
| 1 | 0 | 0 | 25 | 75 | 5/8 |
| 2 | 0 | 10 | 70 | 70 | 7/7 |
| 3 | 0 | 0 | 50 | 60 | 6/7.5 |
| 4 | 0 | 0 | 75 | 75 | 7/7 |
| 5 | 0 | 0 | 60 | 75 | 5/7 |
| 6 | 0 | 0 | 75 | 75 | 7/7 |
| 7 | 0 | 10 | 100 | 100 | 5/5 |
| 8 | 0 | 0 | 70 | 70 | 6/7 |
| Average | 0 | 2.5 | 66 | 67.5 | 6/7 |

CLA taste: 0 no CLA taste, 50 CLA taste, 100 strong CLA taste
Freshness: 0 not fresh, 50 fresh, 100 very fresh
Overall score: 0 very bad, 10 very good

### Example 4

### Preparation of Cookies with Clarinol

Cookies containing CLA were prepared according to the following recipe:
1) Mix shortening, sugar and oil at speed 1 for 1 minute (Hobart mixer). Scrape bowl. Mix at speed 2 for 3 minutes.
2) Add eggs and water step by step until everything is mixed well. Scrape bowl. Mix at speed 2 for 1 minute.
3) Blend flour, skimmed milk powder, baking powder, vanilla powder and salt. Add blend to the rest. Mix at speed 1 for 1 minute. Scrape bowl and mix for 2 minutes at speed 1.
4) Keep dough in the fridge for about 20 minutes.
5) Roll out dough to 5 mm and cut out to give cookies with a diameter of 8.2 cm.
6) Bake at oven setting between 105 and 135° C. for approximately 10 minutes. Turn the tray after 5 minutes.

| | |
|---|---|
| g | % |

Basic recipe (comparative):

| | | |
|---|---|---|
| SHORTENING | 111.55 | 22.31 |
| SUGAR | 107.55 | 21.51 |
| CLARINOL OIL | 0 | 0 |
| EGG | 25 | 5 |
| WATER | 12.5 | 2.5 |
| FLOUR | 225.4 | 45.08 |
| MILK | 13.5 | 2.7 |
| BAKING POWDER | 2 | 0.4 |
| SALT | 2 | 0.4 |
| VANILLA | 0.5 | 0.1 |
| Total: | 500 | 100 |

Recipe containing CLA Oil:

| | | |
|---|---|---|
| SHORTENING | 54.05 | 10.81 |
| SUGAR | 107.55 | 21.51 |
| CLARINOL OIL | 57.50 | 11.50 |
| EGG | 25 | 5 |
| WATER | 12 | 2.4 |
| FLOUR | 225.4 | 45.08 |
| MILK | 13.5 | 2.7 |
| BAKING POWDER | 2 | 0.4 |
| SALT | 2 | 0.4 |
| VANILLA | 1 | 0.2 |
| Total: | 500 | 100 |

d = 8.2 cm,
oil = 5.8%, 1.9 g oil/serving (1,5 active isomers)

Recipe containing CLA Powder:

| | g | % |
|---|---|---|
| SHORTENING | 53.95 | 10.79 |
| SUGAR | 102.75 | 20.55 |
| CLARINOL POWDER | 72 | 14.4 |
| EGG | 25 | 5 |
| WATER | 12 | 2.4 |
| FLOUR | 215.8 | 43.16 |
| MILK | 13.5 | 2.7 |
| BAKING POWDER | 2 | 0.4 |
| SALT | 2 | 0.4 |
| VANILLA | 1 | 0.2 |
| Total: | 500 | 100 |

The cookies containing CLA baked well and tasted at least as good as the comparative cookies that contained no CLA.

The preparation of a material containing high amounts of triglycerides and diglycerides of CLA is set out below.

Experimental

Materials

| | |
|---|---|
| Clarinol A95 (NU-20080812-003) | 3000.0 g |
| RMIM (Lux00205) | 33 g (1 w/w % based on oil) |
| Glycerol | 313.5 g (10.45 w/w % based on oil) |
| Material: | 10 L reaction vessel, 50° C. |

### Experiment

The reaction mixture was prepared by adding 313.5 g glycerol to 3333.0 g CLA A95. The mixture was stirred for 30 minutes at 50° C. During stirring nitrogen is blown through the reaction mixture. The reaction was started by adding 33.542 g RMIM enzyme (a commercially available lipase from Novozym) to the reaction mixture. Nitrogen is blown from the bottom of the reaction vessel through the reaction mixture during the whole reaction time. The mixture is also stirred rapidly during the whole reaction time. Samples are taken during the reaction to monitor the free fatty acid, diglyceride and water percentage in the reaction mixture. The reaction mixture was stopped when the diglyceride percentage was below 25%. The reaction is stopped by filtering the enzyme from the reaction mixture. The whole reaction mixture is brought to the pilot plant for separation on short path distillation (SPD).

SPD Conditions:

| Feed: | 0.4 l/hr |
|---|---|
| Film temperature: | 200° C. |
| Pressure: | 8 * 10⁻³ mbar |
| Residue condition temperature: | 70/75° C. |
| Wiper: | 250 rpm |
| Yield R1/D1: | 80.0%/20.0% |

The analytical results for the resulting high-CLA containing material is set out in the following table. The skilled reader will understand that the exact levels of components may vary from batch to batch, as is normal for such enzyme-mediated processing of natural materials.

| | Residue |
|---|---|
| Description | (G95 material) |
| C15:0 CLA | 0 |
| C14:0 CLA | 0.02 |
| C16:0 CLA | 0.3 |
| C16:1C CLA | 0.02 |
| C17:0 CLA | 0.1 |
| C18:0 CLA | 0.1 |
| CLA_TT CLA | 1.3 |
| CL911C CLA | 0.93 |
| CL1012 CLA | 0.9 |
| CL1113 CLA | 1.2 |
| C18:1T CLA | 0.02 |
| C18:1C CLA | 4.5 |
| CLA_OX CLA | 1.13 |
| C18:2T CLA | 0.54 |
| C18:2C CLA | 0.52 |
| TTnc CLA | 0.6 |
| C20:0 CLA | 0.04 |
| C20:1C CLA | 0.02 |
| C22:0 CLA | 0 |
| SAFA CLA | 0.5 |
| CT.ISO CLA | 88.6 |
| 911CT CLA | 44.1 |
| 1012TC CLA | 44.48 |
| TCLA CLA | 94 |
| poly HPSEC | 0.3 |
| TAG HPSEC | 82.2 |
| DAG HPSEC | 17.3 |
| MAG HPSEC | 0.1 |
| FFA HPSEC | |
| others HPSEC | 0.2 |
| Cu | |
| Ni | |
| Fe | |

1. A dough composition comprising flour, water and a fat phase, wherein the fat phase comprises at least 40% by weight conjugated linoleic acid or a derivative thereof (CLA).

2. A dough composition according to claim 1, wherein the fat phase comprises at least 80% by weight CLA.

3. A dough composition according to claim 1, wherein the fat phase comprises at least 95% by weight CLA.

4. A dough composition of claim 1, wherein the flour is prepared from whole grain.

5. A dough composition of claim 1, wherein the dough composition comprises brown flour.

6. A dough composition of claim 1, wherein the dough composition comprises white flour.

7. A dough composition of claim 1, which comprises a leavening agent.

8. (canceled)

9. A dough composition of claim 1, wherein the flour is a mixture of wheat with other grains.

10. A dough composition of claim 1, which is free of wheat or gluten.

11. (canceled)

12. (canceled)

13. A dough composition of claim 1, wherein the CLA is incorporated in the dough composition in the form of a powder.

14. A dough composition of claim 1 further comprising a bread improver.

15. A bread prepared using the dough composition of claim.

16. A bread improver comprising at least 8% conjugated linoleic acid or a derivative thereof.

17. A bread improver according to claim 16 which comprises ascorbic acid, sodium metabisulphate, ammonium chloride, amylase and/or protease.

18. A process for producing a dough composition of claim 1 comprising admixing flour, water and a fat phase, wherein the fat phase comprises at least 40% by weight CLA, to form the dough composition.

19. (canceled)

20. A process according to claim 18, wherein the CLA is incorporated into the dough composition in the form of a powder.

21. A process according to claim 20, wherein the powder is produced by spray drying CLA, or a fat comprising CLA, with protein and/or carbohydrate.

22. (canceled)

23. (canceled)

24. (canceled)

25. (canceled)

26. A dough composition comprising flour and a fat phase, wherein the fat phase comprises a fat A and a fat B, wherein fat A comprises at least 90% by weight conjugated linoleic acid or a derivative thereof (CLA) and wherein fat B has an N₂₀-value greater than about 10.

27. A dough composition according to claim 26, wherein fat B has an N₂₀-value greater than about 20.

28. A dough composition according to claim 26, wherein fat B has an N₂₀-value in the range of from about 30 to about 80.

29. (canceled)

30. A dough composition of claim 26 wherein fat A comprises at least 95% by weight CLA.

31. A dough composition of claim 26, wherein fat B is selected from the group consisting of butter, cocoa butter equivalents, cocoa butter, palm oil or fractions thereof, palm kernel oil or fractions thereof, interesterified mixtures of above fats or fractions or hardened components thereof, or and from liquid oils, and mixtures thereof.

32. (canceled)

33. (canceled)

34. (canceled)

35. (canceled)

36. (canceled)

37. (canceled)

38. (canceled)

39. (canceled)

40. A biscuit prepared using the dough composition according to claim 26.

41. A cake prepared using the dough composition according to claim 26.

42. Puff pastry prepared using the dough composition according to claim 26.

43. A process for producing a dough composition according to claim 26, comprising admixing flour and a fat phase which comprises a fat A and a fat B, wherein fat A comprises at least 90% by weight conjugated linoleic acid or a derivative thereof (CLA) and wherein fat B has an N₂₀ value greater than about 10, to form the dough composition.

44. (canceled)

45. (canceled)

46. (canceled)

47. A process of claim 43, which further comprises the step of mixing together fat A with fat B to give the fat phase before the fat phase is admixed with the flour.

48. A process of claim 43, which comprises the steps of adding fat A and fat B to the flour separately.

49. (canceled)

50. (canceled)

51. (canceled)

52. (canceled)

53. A dough composition of claim 26 wherein the liquid oil is sunflower oil, high oleic sunflower oil, olive oil, soybean oil, rapeseed oil, cottonseed oil, safflower oil, high oleic safflower oil, maize oil and/or MCT oils.

54. A method for providing a nutritional benefit comprising consuming a product produced using the dough composition of claim 1.

55. The method of claim 54 wherein the benefit is weight management, reduced tendency to fluctuation of body weight, prevention or treatment of atherosclerosis.
